(19) United States
(12) Patent Application Publication
(10) Pub. No.: US 2006/0217471 A1
(43) Pub. Date: Sep. 28, 2006

(54) Fiberglass binder comprising maleinized polyenes

(76) Inventors: Kiarash Alavi Shooshtari, Littleton, CO (US); Jawed Asrar, Greenwood Village, CO (US)

Correspondence Address: JOHNS MANVILLE INTERNATIONAL, INC., 717 SEVENTEENTH STREET, DENVER, CO, 80202, US

(21) Appl. No.: 11/086,166

(22) Filed: Mar. 22, 2005

(51) Int. Cl. C08K 5/00

(52) U.S. Cl. 524/236; 524/384; 524/571; 524/543; 524/567

(57) ABSTRACT

Provided is a fiberglass binder composition which comprises maleinized polyenes and a reactive component selected from the group consisting of alkanolamines, polyols, and monomers containing terminal unsaturation. The resultant binder provides minimal processing difficulties and a fiberglass product which exhibits good water absorption properties.

### FIELD OF THE INVENTION

The subject invention pertains to formaldehyde-free fiberglass binders derived from maleinized polyenes. More particularly, the subject invention pertains to a fiberglass binder comprising maleinized polyenes and a reactive component selected from the group consisting of alkanolamines, polyols, and monomers containing terminal unsaturation. Such binders are useful as replacements for formaldehyde-based binders in non-woven fiberglass goods.

### BACKGROUND OF THE INVENTION

Fiberglass binders have a variety of uses ranging from stiffening applications where the binder is applied to woven or non-woven fiberglass sheet goods and cured, producing a stiffer product; thermo-forming applications wherein the binder resin is applied to a sheet or lofty fibrous product, following which it is dried and optionally B-staged to form an intermediate but yet curable product; and to fully cured systems such as building insulation.

Fibrous glass insulation products generally comprise matted glass fibers bonded together by a cured thermoset polymeric material. Molten streams of glass are drawn into fibers of random lengths and blown into a forming chamber where they are randomly deposited as a mat onto a traveling conveyor. The fibers, while in transit in the forming chamber and while still hot from the drawing operation, are sprayed with an aqueous binder. A phenol-formaldehyde binder has been used throughout the fibrous glass insulation industry. The residual heat from the glass fibers and the flow of air through the fibrous mat during the forming operation are generally sufficient to volatilize the majority to all of the water from the binder, thereby leaving the remaining components of the binder on the fibers as a viscous or semi-viscous high solids liquid. The coated fibrous mat is transferred to a curing oven where heated air, for example, is blown through the mat to cure the binder and rigidly bond the glass fibers together.

Fiberglass binders used in the present sense should not be confused with matrix resins which are an entirely different and non-analogous field of art. While sometimes termed “binders”, matrix resins act to fill the entire interstitial space between fibers, resulting in a dense, fiber reinforced product where the matrix must translate the fiber strength properties to the composite, whereas “binder resins” as used herein are not space-filling, but rather coat only the fibers, and particularly the junctions of fibers. Fiberglass binders also cannot be equated with paper or wood product “binders” where the adhesive properties are tailored to the chemical nature of the cellulosic substrates. Many such resins are not suitable for use as fiberglass binders. One skilled in the art of fiberglass binders would not look to cellulosic binders to solve any of the known problems associated with fiberglass binders.

Binders useful in fiberglass insulation products generally require a low viscosity in the uncured state, yet characteristics so as to form a rigid thermoset polymeric mat for the glass fibers when cured. A low binder viscosity in the uncured state is required to allow the mat to be sized correctly. Also, viscous binders tend to be tacky or sticky and hence they lead to accumulation of fiber on the forming chamber walls. This accumulated fiber may later fall onto the mat causing dense areas and product problems. A binder which forms a rigid matrix when cured is required so that a finished fiberglass thermal insulation product, when compressed for packaging and shipping, will recover to its as-made vertical dimension when installed in a building.

From among the many thermosetting polymers, numerous candidates for suitable thermosetting fiberglass binder resins exist. However, binder-coated fiberglass products are often of the commodity type, and thus cost becomes a driving factor, generally ruling out such resins as thermosetting polyurethanes, epoxies, and others. Due to their excellent cost/performance ratio, the resins of choice in the past have been phenol/formaldehyde resins. Phenol/formaldehyde resins can be economically produced, and can be extended with urea prior to use as a binder in many applications. Such urea-extended phenol/formaldehyde binders have been the mainstay of the fiberglass insulation industry for years, for example.

Over the past several decades however, minimization of volatile organic compound emissions (VOCs) both on the part of the industry desiring to provide a cleaner environment, as well as by Federal regulation, has led to extensive investigations into not only reducing emissions from the current formaldehyde-based binders, but also into candidate replacement binders. For example, subtle changes in the ratios of phenol to formaldehyde in the preparation of the basic phenol/formaldehyde resole resins, changes in catalysts, and addition of different and multiple formaldehyde scavengers, has resulted in considerable improvement in emissions from phenol/formaldehyde binders as compared with the binders previously used. However, with increasingly stringent Federal regulations, more and more attention has been paid to alternative binder systems which are free from formaldehyde.

One such candidate binder system employs polymers of acrylic acid as a first component, and a polyol such as glycerine or a modestly oxyalkylated glycerine as a curing or “crosslinking” component. The preparation and properties of such poly(acrylic acid)-based binders, including information relative to the VOC emissions, and a comparison of binder properties versus urea formaldehyde binders is presented in “Formaldehyde-Free Crosslinking Binders For Non-Wovens”, Charles T. Arkins et al., TAPPI JOURNAL, Vol. 78, No. 11, pages 161-168, November 1995. The binders disclosed by the Arkins article, appear to be B-stageable as well as being able to provide physical properties similar to those of urea/formaldehyde resins.

U.S. Pat. No. 5,340,868 discloses fiberglass insulation products cured with a combination of a polycarboxy polymer, a-hydroxyalkylamide, and an at least one trifunctional monomeric carboxylic acid such as citric acid. The specific polycarboxy polymers disclosed are poly(acrylic acid) polymers. See also, U.S. Pat. No. 5,143,582

U.S. Pat. No. 5,318,990 discloses a fibrous glass binder which comprises a polycarboxy polymer, a monomeric trihydric alcohol and a catalyst comprising an alkali metal salt of a phosphorous-containing organic acid.

U.S. Pat. No. 6,121,398 discloses the synthesis of liquid molding resins derived from plant oils that are capable of curing to high modulus thermosetting polymbers and composites.

Published European Patent Application EP 0 583 086 A1 appears to provide details of polyacrylic acid binders whose cure is catalyzed by a phosphorus-containing catalyst system as discussed in the Arkins article previously cited. Higher molecular weight poly(acrylic acids) are stated to provide polymers exhibiting more complete cure. See also U.S. Pat. Nos. 5,661,213; 5,427,587; 6,136,916; and 6,221,973.

Some polycarboxy polymers have been found useful for making fiberglass insulation products. Problems of clumping or sticking of the glass fibers to the inside of the forming chambers during the processing, as well as providing a final product that exhibits the recovery and rigidity necessary to provide a commercially acceptable fiberglass insulation product, have been overcome. See, for example, U.S. Pat. No. 6,331,350. The thermosetting acrylic resins have been found to be more hydrophilic than the traditional phenolic binders, however. This hydrophilicity can result in fiberglass insulation that is more prone to absorb liquid water, thereby possibly compromising the integrity of the product. Also, the thermosetting acrylic resins now being used as binding agents for fiberglass have been found to not react as effectively with silane coupling agents of the type traditionally used by the industry. The addition of silicone as a hydrophobing agent results in problems when abatement devices are used that are based on incineration. Also, the presence of silicone in the manufacturing process can interfere with the adhesion of certain facing substrates to the finished fiberglass material. Overcoming these problems will help to better utilize polycarboxy polymers in fiberglass binders.

Accordingly, it is an objective of the present invention to provide a novel, non-phenol/formaldehyde binder.

Yet another object of the present invention is to provide such a binder which allows one to prepare fiberglass insulation products which are more water repellent and less prone to absorb liquid water.

Still another object of the present invention is to provide a fiberglass insulation product which exhibits good recovery and rigidity, is formaldehyde-free, and is more water-proof.

These and other objects of the present invention will become apparent to the skilled artisan upon a review of the following description and the claims appended hereto.

### SUMMARY OF THE INVENTION

In accordance with the foregoing objectives, there is provided by the present invention a novel fiberglass binder. The binder composition of the present invention comprises a maleinized polyene and a reactive component selected from the group consisting of alkanolamines, polyols, and monomers containing terminal unsaturation.

Further provided is a process for preparing a fiberglass binder comprising maleinizing a polyunsaturated glyceride and then co-polymerizing the maleinized glyceride with a reactive component selected from the group consisting of alkanolamines, polyols, and monomers containing terminal unsaturation.

### DETAILED DESCRIPTION OF THE PREFERRED EMBODIMENTS

The binder of interest with regard to the present invention is a formaldehyde free binder useful for glass fibers. Of particular interest is a binder composition of maleinized polyenes and a reactive component selected from the group consisting of alkanolamines, polyols, and monomers containing terminal unsaturation. The binder may also contain a curing agent. The binder provides a fiberglass product which exhibits good water absorption properties.

According to the present invention, polyenes are any organic compound containing more than one double bond. In certain embodiments, preferably the polyenes suitable for use in the present invention have a molecular weight of greater than 100 and preferably greater than 200. Maleinized polyenes, suitable for use in the binders of the present invention, are any polyenes having maleinic functionality. Accordingly, the maleinized polyenes of the present invention may be made by maleinization of suitable polyenes. To provide the maleinized polyenes, maleic anhydride is well known to react with polyenes in an ene reaction at the sites of unsaturation.

Examples of polyenes that may be maleinized to provide the maleinized polyenes of the present invention include, but are not limited to, polyunsaturated glycerides, polyunsaturated fatty acids, polybutadiene, polyethylene, polypropylene, polyisopropylene, betacarotene, polyacetylenes (PAs), polydiacetylenes (PDAs), polyparaphenylenevinylenes (PPV), polyvinyl chloride, polytetrafluoroethylene, and the like, and mixtures thereof. Examples of polyunsaturated fatty acids include, but are not limited to, linoleic acid, linolenic acid, arachidonic acid, eicosapentaenoic acid (EPA), 4,7,10,13,16,19-docosahexaenoic acid, and the like.

In preferred embodiments, the maleinized polyenes are maleinized glycerides. To provide the maleinized glycerides, polyunsaturated glycerides are maleinized by reactions and methods well known to those of skill in the art. Maleic anhydride is well known to react with polyunsaturated glycerides in an ene reaction (maleinization) to provide maleinized glycerides. The polyunsaturated glycerides used to provide the maleinized glycerides may be unfunctionalized polyunsaturated glycerides or functionalized polyunsaturated glycerides, for example hydroxylated, epoxidized, or combinations thereof, as long as more than one double bond is retained. Preferably, the polyunsaturated glycerides of the present invention are unfunctionalized. In addition, these polyunsaturated glycerides may be monoglycerides, diglycerides, triglycerides, or mixtures thereof. In certain preferred embodiments, the polyunsaturated glycerides are derived from plant oils.

When polyunsaturated triglycerides are used, the triglyceride molecular structure is a combination of various triesters of at least one polyunsaturated fatty acids linked together with glycerol where the fatty acid residues are linear carboxylic acids containing from about 4 to about 30 carbon atoms, preferably from about 12 to 18 carbon atoms, and from 2 to about 4 carbon-carbon double bonds. The polyunsaturated triglycerides are preferably natural polyunsaturated oils derived from plants. Polyunsaturated plant oils that may be suitable for use in the present invention include, for example, linseed oils (flaxseed oils), soybean oils, safflower oils, corn oils, sunflower oils, cottonseed oils, rice bran oils, colza oils, hemp seed oils, seasame oils, and the like, and mixtures thereof.

Reactions to functionalize glycerides, including hydroxylation reactions and epoxidation reactions, are well known to those of skill in the art. Epoxidation of glycerides may be accomplished using air oxidation, enzyme-lipase, peracids such as acetic acid or formic acid, or hydrogen peroxide. Epoxidation creates cyclic 3-membered oxygen containing rings within the alkyl chains of the fatty acid residues. Hydroxylation of glycerides can be accomplished using hydrogen peroxide in the presence of acid such that initially the glyceride is epoxidized but the epoxy groups are converted directly to hydroxy groups. In addition, epoxidized and hydroxylated glycerides suitable for use in the present invention are commercially available products. According to the present invention, the hydroxylated and epoxidized glycerides must retain more than one double bond. Preferably, the polyunsaturated glycerides of the present invention are unfunctionalized.

In certain preferred embodiments, the maleinized polyenes are the reaction product of polyunsaturated monoglycerides and maleic anhydride. Alcoholysis of triglycerides with alcohols to yield monoglycerides is well known to those of skill in the art. In other preferred embodiments, the maleinized polyenes are the reaction product of polyunsaturated triglycerides and maleic anhydride. Maleic anhydride is well known to react with polyunsaturated glycerides in an ene reaction. The degree of maleinization of the polyunsaturated glycerides can be controlled by the amount of maleic anhydride used in the reaction and can be from about 1 to about 10 anhydride residues per triglyceride, preferably about 4 to about 6 anhydride residues per triglyceride.

The binders according to the present invention further comprise a reactive component selected from the group consisting of alkanolamines, polyols, and monomers containing terminal unsaturation. The maleinized polyenes of the present invention crosslink with the reactive component providing a cured binder resin. Accordingly, the binders of the present invention may further comprise a curing agent. The desired cross-link density and cross-link segment lengths can be obtained by adjusting the relative amounts of the maleinized polyenes and reactive component and by the addition of one or more curing agents.

According to the present invention, alkanolamines are any organic compounds of the formula NR¹R²R³ wherein R¹, R² and R³ are independently selected from H, alkyl, and alkyl alcohols, provided that at least one of R¹, R² and R³ is an alkyl alcohol. Examples of suitable alkanolamines include, but are not limited to ethanol amine, diethanolamine, triethanolamine, diethylethanolamine, dimethylethanolamine, methyldiethanolamine, methylethanolamine, and the like. The alkanolamines can crosslink with the maleinized polyenes through ester and amide formation. However, if the alkanolamines do have more than one hydroxy group (i.e., diethanolamine), the crosslinking may also proceed by ester formation as described below with regard to polyols. Reaction conditions for cross-linking the maleinized polyenes with alkanolamines are well known to those of skill in the art.

When polyols are used as the reactive component in the binder composition, polyols suitable for use are any organic compound having more than one hydroxy (—OH) group per molecule that is capable of crosslinking with the maleinized polyenes. Accordingly, the polyols include diols, triols, and the like. The polyol must be sufficiently nonvolatile such that it will substantially remain available for reaction with the maleinized polyenes in the binder composition during heating and curing operations. Suitable polyols include polyols selected from the group consisting of polyester polyols, polyurethane polyols, polyether polyols, and mixtures thereof. Examples of suitable polyols include, but are not limited to, diethanol amine, triethanol amine, bisphenol-A, ethylene glycol, glycerol, pentaerythritol, trimethylol propane, sorbitol, inisitol, glucose, sucrose, polyvinyl alcohol, starch, resorcinol, catechol, pyrogallol, glycollated ureas, 1,4-cyclohexane diol, and the like, and mixtures thereof. The diols and triols generally crosslink with the maleinized polyenes by ester formation. Reaction conditions for cross-linking the maleinized polyenes with polyols are well known to those of skill in the art.

When monomers containing terminal unsaturation are used as the reactive component in the binder composition, monomers suitable for use are any monomer containing at least terminal unsaturation that will cross-link or co-polymerize with the maleinized polyenes by free radical polymerization. Examples of suitable monomers containing terminal unsaturation are selected from the group consisting of styrene, vinyl toluene, divinylbenzene, lower alkyl(meth)acrylate, lower alkyl acrylates, ethylene glycol dimethylacrylate, di and tri acrylated glycols (e.g., triethylene glycol triacrylate) and the like, and mixtures thereof.

As used herein, “lower alkyl” refers to monovalent alkyl groups having from 1 to 5 carbon atoms including straight and branched chain alkyl groups, which groups may be optionally substituted. By way of example, the straight and branched chain alkyl groups optionally may be substituted with one or more hydroxy (—OH) groups. This term is exemplified by groups such as methyl, hydroxymethyl, ethyl, hydroxyethyl, iso-propyl, n-propyl, n-butyl, iso-butyl, sec-butyl, t-butyl, n-pentyl and the like. Accordingly, lower alkyl (meth)acrylates may be methyl methacrylate, butyl methacrylate, hydroxyethylmethacrylate, and the like, and mixtures thereof. According to the present invention, the monomers with terminal unsaturation copolymerize with the maleinized polyenes by reaction at the double bond. Reaction conditions for cross-linking or co-polymerizing the maleinized polyenes with the monomers containing terminal unsaturation are well known to those of skill in the art.

The binder composition may comprise from about 10 to 90 weight percent maleinized polyenes and from about 90 to 10 weight percent reactive component selected from the group consisting of alkanolamines, polyols, and monomers containing terminal unsaturation.

The cured binder according to the present invention is prepared by crosslinking or co-polymerizing the maleinized polyenes with the reactive component selected from the group consisting of alkanolamines, polyols, and monomers containing terminal unsaturation by methods well known to those of skill in the art. The maleinized polyenes are reactive. The crosslinking and curing reaction preferably is conducted at elevated temperatures, e.g., between about 100° C. and 400° C. A curing agent may be added to assist in the crosslinking and curing reaction. In embodiments when the binder composition further comprises a curing agent, the binder may comprise from about 0.01 to 10 weight percent curing agent based on the combined weight of the maleinized polyenes and reactive component.

The curing agent may be selected according to the reactive component to be co-polymerized with the maleinized polyenes and the degree of crosslink density desired in the cured binder. The curing agent may be a crosslinking catalyst or a free radical or photo initiator.

In certain embodiments, the curing agent may be a free radical initiator or a photoinitiator. Suitable free radical initiators and photoinitiators include, but are not limited to, benzoyl peroxide, dicumyl peroxide, azo compounds such as azoisobutyronitrile (AIBN), t-butylhydroperoxide, benzophenone, cobalt compounds, and the like. The free radical initiator may be used at a level of from about 1 weight percent to about 10 weight percent based on the combined weight of the maleinized polyenes and reactive component.

In other embodiments, the curing agent may be a crosslinking catalyst. Examples of suitable crosslinking catalysts include phosphorus containing catalysts, tertiary amines such as triethylamine (TEA), mineral acids such as H₂SO₄, HCl, sulfonic acids such as p-toluene sulfonic acid (PTSA) and methane sulfonic acid, organotitanate compounds, organotin compounds, and the like. The phosphorus containing catalyst may be a compound with a molecular weight less than about 1000 such as, for example, an alkali metal polyphosphate, an alkali metal dihydrogen phosphate, a polyphosphoric acid, and an alkyl phosphinic acid or it may be an oligomer or polymer bearing phosphorous-containing groups such as, for example, addition polymers of acrylic and/or maleic acids formed in the presence of sodium hypophosphite, addition polymers prepared from ethylenically unsaturated monomers in the presence of phosphorous salt chain transfer agents or terminators, and addition polymers containing acid-functional monomer residues such as, for example, copolymerized phosphoethyl methacrylate, and like phosphonic acid esters, and copolymerized vinyl sulfonic acid monomers, and their salts. The phosphorous-containing catalyst may be used at a level of from about 1 weight percent to about 10 weight percent based on the combined weight of the maleinized polyenes and reactive component. Preferred is a level of phosphorous-containing accelerator of from about 2.5 weight percent to about 10 weight percent based on the combined weight of the maleinized polyenes and reactive component.

The binder composition according to the present invention may also contain conventional treatment components or additives, such as, for example, solvents, emulsifiers, pigments, filler, anti-migration aids, coalescents, wetting agents, biocides, plasticizers, organosilanes, anti-foaming agents, colorants, waxes, suspending agents, fillers, anti-oxidants, and mixtures thereof.

The binder composition may be prepared by admixing the maleinized polyenes of the present invention with the reactive component selected from the group consisting of alkanolamines, polyols, and monomers containing terminal unsaturation using conventional mixing techniques. In certain embodiments, the binder compositions may be prepared by maleinizing a polyunsaturated glyceride as described herein to provide maleinized polyenes and then admixing the maleinized polyenes of the present invention with the reactive component selected from the group consisting of alkanolamines, polyols, and monomers containing terminal unsaturation using conventional mixing techniques. Optionally, curing agent may also be admixed with the maleinized polyenes and reactive component.

After the binder composition of the present invention comprising maleinized polyenes, reactive component, and optionally curing agent has been prepared, other conventional additives can then be mixed in with the composition to form the final composition. The final binder composition then can be applied to fiberglass. As molten streams of glass are drawn into fibers of random lengths and blown into a forming chamber where they are randomly deposited as a mat onto a traveling conveyor, the fibers, while in transit in the forming chamber, are sprayed with the binder composition of the present invention.

The binder according to the present invention may be applied to the fibers neat. In the alternative, the binder may be applied to the fibers as an emulsion, suspension, or solution. Preferably, the binder is applied to the fibers as a solution in a solvent sufficiently volatile such that during the subsequent heating of the binder to cure, the solvent will evaporate. Applying the binder in solution assists in controlling the viscosity of the binder. Suitable solvents include water, acetone, methanol, ethanol, and the like, and mixtures thereof. When applied as a solution, the binder can be sprayed on the surface and the subsequent heating of the binder to cure will evaporate the solvent in which the binder was applied.

After application to the fibers, preferably the binder is heated to crosslink or co-polymerize the components to provide a cured binder.

More particularly, in the preparation of fiberglass insulation products, the products can be prepared using conventional techniques. As is well known, a porous mat of fibrous glass can be produced by fiberizing molten glass and immediately forming a fibrous glass mat on a moving conveyor. The expanded mat is then conveyed to and through a curing oven wherein heated air is passed through the mat to cure the resin. The mat is slightly compressed to give the finished product a predetermined thickness and surface finish. Typically, the curing oven is operated at a temperature from about 150° C. to about 325° C. Preferably, the temperature ranges from about 180° C. to about 225° C. Generally, the mat resides within the oven for a period of time from about ½ minute to about 3 minutes. For the manufacture of conventional thermal or acoustical insulation products, the time ranges from about ¾ minute to about 1½ minutes. The fibrous glass having a cured, rigid binder matrix emerges from the oven in the form of a bat which may be compressed for packaging and shipping and which will thereafter substantially recover its vertical dimension when unconstrained.

The curable binder composition of the present invention may also be applied to an already formed nonwoven by conventional techniques such as, for example, air or airless spraying, padding, saturating, roll coating, curtain coating, beater deposition, coagulation, or the like.

The binder composition of the present invention, after it is applied to a nonwoven, is heated to effect drying and curing. If applied as a solution, the heating is sufficient to evaporate the solvent and remove any residual solvent from the binder composition. The duration and temperature of heating will affect the rate of drying, processability and handleability, and property development of the treated substrate. Heat treatment at about 100° C., to about 400° C., for a period of time between about 3 seconds to about 15 minutes may be carried out; treatment at about 100° C., to about 250° C., is preferred. The drying and curing functions may be effected in two or more distinct steps, if desired. For example, the composition may be first heated at a temperature and for a time sufficient to substantially dry but not to substantially cure the composition and then heated for a second time at a higher temperature and/or for a longer period of time to effect curing. Such a procedure, referred to as “B-staging”, may be used to provide binder-treated nonwoven, for example, in roll form, which may at a later stage be cured, with or without forming or molding into a particular configuration, concurrent with the curing process.

The heat-resistant nonwovens may be used for applications such as, for example, insulation batts or rolls, as reinforcing mat for roofing or flooring applications, as roving, as microglass-based substrate for printed circuit boards or battery separators, as filter stock, as tape stock, as tape board for office petitions, in duct liners or duct board, and as reinforcement scrim in cementitious and non-cementitious coatings for masonry. Most preferably, the products are useful as thermal or sound insulation. The nonwovens can also be used as filtration media for air and liquids.

The present invention will be further illustrated by the following examples, which are in no manner meant to be limiting in scope.

### EXAMPLES

### Example 1

Linseed oil (obtained from Archer Daniels Midland, Peoria, Ill.) was maleinized using maleic anhydride to provide maleinized linseed oil. Maleinized linseed oil (2.5 g) was dissolved in 10.0 g acetone to provide a solution. To this solution 0.30 g ethanol amine was added and the mixture was stirred to become uniform. The mixture was applied on glass and Al panel at 10 mil wet film, air dried for 10 minutes and then cured in an oven at 200° C. for 10 minutes to produce a light amber-flexible film.

### Example 2

Linseed oil (obtained from Archer Daniels Midland, Peoria, Ill.) was maleinized using maleic anhydride to provide maleinized linseed oil. Maleinized linseed oil (2.5 g was dissolved in 10.0 g acetone to provide a solution. To this solution 0.30 g diethanol amine was added and the mixture was stirred to become uniform. The mixture was applied on glass and Al panel at 10 mil wet film, air dried for 10 minutes and then cured in an oven at 200° C. for 10 minutes to produce a light amber-flexible film.

### Example 3

Linseed oil (obtained from Archer Daniels Midland, Peoria, Ill.) was maleinized using maleic anhydride to provide maleinized linseed oil. Maleinized linseed oil (2.5 g) was dissolved in 10.0 g acetone to provide a solution. To this solution 0.25 g trimethylol propane was added and the mixture was stirred at 40° C. in a capped vial to become uniform. The mixture was applied on glass and Al panel at 10 mil wet film, air dried for 10 minutes and then cured in an oven at 200° C. for 10 minutes to produce a light amber-flexible film.

### Example 4

Linseed oil (obtained from Archer Daniels Midland, Peoria, Ill.) was maleinized using maleic anhydride to provide maleinized linseed oil. Maleinized linseed oil (4.76 g) was emulsified in 10.0 g water containing 2.50 g triethanol amine to provide a solution. The solution was applied on glass and Al panel at 10 mil wet film, air dried for 10 minutes and then cured in an oven at 200° C. for 10 minutes to produce a tough film.

### Example 5

As prepared in Examples 1-4, the binder compositions can be used to prepare fiberglass bats as follows: Molten streams of glass are drawn into fibers of random lengths and blown into a forming chamber where they are randomly deposited as a mat onto a traveling conveyor. The fibers while in transit in the forming chamber are sprayed with the binder compositions of Examples 1-4. The expanded mat is then conveyed to and through a curing oven wherein heated air is passed through the mat to cure the resin. The mat is slightly compressed to give the finished product a predetermined thickness and surface finish. Typically, the curing oven is operated at a temperature from about 150° C. to about 325° C. and the mat resides within the oven for a period of time from about ½ minute to about 3 minutes. The fibrous glass having a cured, rigid binder matrix emerges from the oven in the form of a bat.

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A fiberglass binder comprising maleinized polyenes and a reactive component selected from the group consisting of alkanolamines, polyols, and monomers containing terminal unsaturation.

2. The fiberglass binder of claim 1, wherein the polyene is selected from the group consisting of polyunsaturated glycerides, polyunsaturated fatty acids, polybutadiene, polyethylene, polypropylene, polyisopropylene, betacarotene, polyacetylenes (PAs), polydiacetylenes (PDAs), polyparaphenylenevinylenes (PPV), polyvinyl chloride, and polytetrafluoroethylene.

3. The fiberglass binder of claim 1, wherein the maleinized polyene is maleinized glyceride.

4. The fiberglass binder of claim 3, wherein the maleinized polyene is the reaction product of polyunsaturated monoglycerides and maleic anhydride.

5. The fiberglass binder of claim 3, wherein the maleinized polyene is the reaction product of polyunsaturated diglycerides and maleic anhydride.

6. The fiberglass binder of claim 1, wherein the maleinized polyene is the reaction product of polyunsaturated triglycerides and maleic anhydride.

7. The fiberglass binder of claim 6, wherein the polyunsaturated triglyceride is a plant oil.

8. The fiberglass binder of claim 7, wherein the oil is selected from the group consisting of linseed oils, soybean oils, safflower oils, corn oils, sunflower oils, cottonseed oils, rice bran oils, colza oils, hemp seed oils, seasame oils, and mixtures thereof.

9. The fiberglass binder of claim 1, wherein the reactive component is a polyol selected from the group consisting of polyester polyols, polyurethane polyols, polyether polyols, and mixtures thereof.

10. The fiberglass binder of claim 1, wherein the reactive component is a polyol selected from the group consisting of diethanol amine, triethanol amine, bisphenol-A, ethylene glycol, glycerol, pentaerythritol, trimethylol propane, sorbitol, inisitol, glucose, sucrose, polyvinyl alcohol, starch, resorcinol, catechol, pyrogallol, glycollated ureas, 1,4-cyclohexane diol, and mixtures thereof.

11. The fiberglass binder of claim 1, wherein the reactive component is a monomer containing terminal unsaturation selected from the group consisting of styrene, vinyl toluene, divinylbenzene, lower alkyl(meth)acrylate, lower alkyl acrylates, ethylene glycol dimethylacrylate, diacrylated glycols, triacrylated glycols, and mixtures thereof.

12. The fiberglass binder of claim 1, wherein the reactive component is an alkanolamine.

13. The fiberglass binder of claim 11, wherein the reactive component is a lower alkyl(meth)acrylate is selected from the group consisting of methyl methacrylate, butyl methacrylate, hydroxyethylmethacrylate, and mixtures thereof.

14. The fiberglass binder of claim 1, wherein the fiberglass binder further comprises a component selected from the group consisting of solvents, emulsifiers, pigments, filler, anti-migration aids, coalescents, wetting agents, biocides, plasticizers, organosilanes, anti-foaming agents, colorants, waxes, suspending agents, fillers, anti-oxidants, and mixtures thereof.

15. The fiberglass binder of claim 1, wherein the binder further comprises a curing agent.

16. The fiberglass binder of claim 15, wherein the curing agent is a free radical initiator or a photoinitiator.

17. The fiberglass binder of claim 16, wherein the free radical initiator or photoinitiator is selected from the group consisting of benzoyl peroxide, dicumyl peroxide, azoisobutyronitrile, t-butylhydroperoxide, and benzophenone.

18. The fiberglass binder of claim 15, wherein the curing agent is a crosslinking catalyst selected from the group consisting of phosphorus containing catalysts, trethylamine, mineral acids, sulfonic acids, organotitanate compounds, and organotin compounds.

19. A process for preparing a fiberglass binder comprising maleinizing a polyunsaturated glyceride and then co-polymerizing the maleinized glyceride with a reactive component selected from the group consisting of alkanolamines, polyols, and monomers containing terminal unsaturation.

20. The process of claim 19, wherein the polyunsaturated glyceride is selected from polyunsaturated monoglycerides, polyunsaturated diglycerides, polyunsaturated triglycerides, and mixtures thereof.

21. The process of claim 20, wherein the polyunsaturated triglyceride is a plant oil.

22. The process of claim 21, wherein the oil is selected from the group consisting of linseed oils, soybean oils, safflower oils, corn oils, sunflower oils, cottonseed oils, rice bran oils, colza oils, hemp seed oils, seasame oils, and mixtures thereof.

23. The process of claim 19, further comprising applying the binder to a mat of glass fibers.

24. The process of claim 23, wherein the binder is applied neat.

25. The process of claim 23, wherein the binder is applied as an emulsion, suspension, or solution.

26. A fiberglass product comprising a mat of glass fibers containing the binder of claim 1.

27. The fiberglass product of claim 26, wherein the product is building insulation.
